(19) United States
(12) Patent Application Publication
(10) Pub. No.: US 2013/0221173 A1
(43) Pub. Date: Aug. 29, 2013

(54) MAGNETIC HANGING APPARATUS

(71) Applicant: John Ellis Glover, Wildwood, NJ (US)

(72) Inventor: John Ellis Glover, Wildwood, NJ (US)

(21) Appl. No.: 13/778,787

(22) Filed: Feb. 27, 2013

Related U.S. Application Data
(60) Provisional application No. 61/604,182, filed on Feb. 28, 2012.

(51) Int. Cl. F16M 13/02

(52) U.S. Cl. CPC F16M 13/02
USPC 248/206.5; 29/428

(57) ABSTRACT

A magnetic hanging apparatus is provided having a housing element and an extension element. The housing element includes a first end surface, a second end surface, a body portion, a central bore extending through the body portion from the first end surface to the second end surface, and a recessed portion at the second end surface. The extension element is partially located within the central bore and includes a first end and a second end. The first end extends from the first end surface and away from the body portion. The second end is housed in the central bore. A magnet is housed in the recessed portion.

This application claims the benefit of U.S. Provisional Application No. 61/604,182, which was filed Feb. 28, 2012 and is incorporated herein by reference as if fully set forth.

### FIELD OF INVENTION

This application is generally related to hanging devices and more particularly related to a magnetic hanging device for decorating.

### BACKGROUND

Ornamental decorations are widely used to celebrate holidays, special occasions, and seasonal events. Affixing decorations to walls or other surfaces typically requires nails or other hanging aids to support the weight of the decorations and hold the decorations in the desired location. The use of nails or other hanging aids commonly results in permanent alterations to the hanging surface. Vacant nail holes and other disfiguring marks on the hanging surface often results from using existing hanging aids. Additionally, in order to adjust or move the decoration to a new location, the hanging aid must be completely removed from the hanging surface and reinserted at the new location, thus increasing the undesired disfiguring marks on the hanging surface.

### SUMMARY

In an aspect, the invention relates to a magnetic hanging apparatus. The magnetic hanging apparatus includes a housing element having a first end surface, a second end surface, and a body portion. The second end surface includes a magnet. The magnetic hanging apparatus also includes an extension element having a first end and a second end. The first end of the extension element extends from the first end surface and away from the body portion and the second end is fastened to the body portion.

In an aspect, the invention relates to a magnetic hanging apparatus including a housing element and an extension element. The housing element includes a first end surface, a second end surface, a body portion, a central bore extending at least partially through the body portion from the first end surface toward the second end surface, and a recessed portion at the second end surface. The extension element is partially located within the central bore and includes a first end and a second end. The first end extends from the first end surface and away from the body portion. The second end is housed in the central bore. A magnet is housed in the recessed portion.

In an aspect, the invention relates to a magnetic hanging apparatus including a body including a connector at an axial end of the body, wherein the connector includes a magnet, flat metal portion, or a recess. The apparatus also includes an attachment assembly including a flexible element with a first end fastened to the body. A second end of the attachment assembly includes a fastening element that can be operably connected to the connector.

In an aspect, the invention relates to a method of decorating or providing a display comprising affixing a magnetic hanging apparatus to a surface and attaching an ornament or display item thereto. The magnetic hanging apparatus includes a housing element having a first end surface, a second end surface, and a body portion. The second end surface includes a magnet. The magnetic hanging apparatus also includes an extension element having a first end and a second end. The first end of the extension element extends from the first end surface and away from the body portion and the second end is fastened to the body portion. The method also includes pressing the second end surface of the housing element against the surface. The method also includes placing the second magnet on an opposite side of the surface in comparison to the second end of the housing element and the first magnet and the second magnet are operably connected to keep the magnetic hanging apparatus in place.

In an aspect, the invention relates to a method of decorating or providing a display including affixing a magnetic hanging apparatus to a surface and attaching an ornament or display item thereto. The magnetic hanging apparatus includes a housing element and an extension element. The housing element includes a first end surface, a second end surface, a body portion, a central bore extending at least partially through the body portion from the first end surface toward the second end surface, and a recessed portion at the second end surface. The extension element is partially located within the central bore and includes a first end and a second end. The first end extends from the first end surface and away from the body portion. The second end is housed in the central bore. A magnet is housed in the recessed portion. The method also includes pressing the second end surface of the housing element against the surface. The one or more secondary magnets are placed on an opposite side of the surface in comparison to the magnet.

In an aspect, the invention relates to a method of decorating or providing a display including affixing a magnetic hanging apparatus on a substrate element by wrapping a flexible element around the substrate element and operably connecting a second end of the flexible element to a connector of a body.

### BRIEF DESCRIPTION OF THE DRAWINGS

The following detailed description of the preferred embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a side perspective view of an embodiment of the magnetic hanging apparatus.

FIG. 2 is a side cross-sectional view of an alternative embodiment of the magnetic hanging apparatus.

FIG. 3 is an exploded perspective view of the magnetic hanging apparatus shown in FIG. 2.

FIG. 4 is a side cross-sectional view of an alternative embodiment of the magnetic handing apparatus.

### DETAILED DESCRIPTION OF THE PREFERRED EMBODIMENTS

Certain terminology is used in the following description for convenience only and is not limiting. The words “front,” “back,” “left,” “right,” “inner,” “outer,” “upper,” “lower,” “top,” and “bottom” designate directions in the drawings to which reference is made. Additionally, the terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

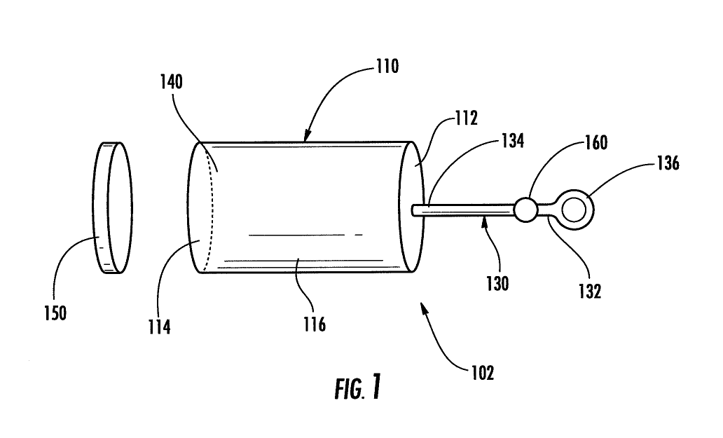

FIG. 1 shows an embodiment of a magnetic hanging apparatus 102 according to the present application. The magnetic hanging apparatus 102 includes a housing element 110 and an extension element 130. The housing element 110 includes a first end surface 112, a second end surface 114, and a body portion 116. The body portion 116 may be any appropriate shape. The body portion 116 may have a smooth outer surface on which decorative elements may be attached. The body portion 116 may also have one or more holes for inserting a variety of decorative items. The first end surface 112 and second end surface 114 may be of any shape and may be annular. The cross section of the first end surface 112 and the second end surface 114 may match or may be different. The cross section of the first end surface 112 may be smaller than the cross section of the second end surface 114.

The second end surface 114 includes a magnet 140. The magnet 140 may be disc-shaped. The magnet 140 may be any type of magnet. The magnet 140 may be a neodymium magnet. The magnet 140 may provide adequate strength to support the weight of the magnetic hanging apparatus 102 and items hanging from the apparatus 102. The magnet 140 may be integral with the second end surface 114. Alternatively, the magnet 140 may be glued or otherwise attached to the second end surface 114. The magnet 140 may be removably attached to the second end surface 114. The removable attachment may be a magnetic interaction between the magnet 140 and one or more other structure of the apparatus 102. The removable attachment may include fitting the magnet 140 into or onto structures at the second end surface 114 adapted to receive the magnet 140. The second end surface 114 may include a first ferromagnetic material.

The extension element 130 has a first end 132 and a second end 134. The extension element 130 extends from the first end surface 112 and away from the body portion 116 of the housing element 110. The extension element 130 may be rigid. The extension element 130 may be a chain, rod, string, rope, yarn, strap, or cable. The extension element 130 may be sufficiently ductile to allow the element to keep a new shape after adjustment. The extension element 130 is illustrated as a straight member, but the extension element 130 may have a different shape than illustrated. The second end 134 of the extension element 130 is fastened to the first end surface 112 of the housing element 110. The extension element 130 may be integral with, soldered, or glued to the first end surface 112 of the housing element 110. The second end 134 may extend into a bore in the housing element 110. The bore may extend from the first end surface 112 toward the second end surface 114. The bore may extend from the first end surface 112 through to the second end surface 114. The first end 132 of the extension element 130 may include a fastening element 136. Any suitable fastening element 136 may be used. A fastening element 136 could be but is not limited to a clasp, hook, or ring. The fastening element 136 is configured to provide an attachment support between the extension element 130 and a feature to be displayed. The feature to be displayed may be an ornament or a display item. The display item may be but is not limited to jewelry. Multiple fastening elements may be provided for supporting multiple ornaments and/or display items.

One or more secondary magnets 150 may be provided for affixing the magnetic hanging apparatus 102 to a suitable surface that is not magnetic, or not sufficiently magnetic to retain the magnetic hanging apparatus 102. The secondary magnet 150 may be any type of magnet. The secondary magnet 150 may be a disc-shaped neodymium magnet. The secondary magnet 150 is operably connected to the magnet 140 included in the second end surface 114. The secondary magnet 150 may be placed on the opposite side of any wall or other structure providing an attachment surface in the corresponding opposite position of the magnet 140 included in the second end surface 114. In an operably connected configuration, the magnetic force between magnet 140 and secondary magnet 150 provides adequate support to hold the hanging apparatus 102 and any items hanging from the hanging apparatus 102 in place on the wall or other structure. The magnetic hanging apparatus 102 may be affixed to non-metal surfaces, such as glass and upholstery through use of the secondary magnet 150. In an embodiment, magnet 140 is absent, but the apparatus includes ferromagnetic material and the secondary magnet 150 can be positioned on the opposite side of the wall or other structure. A ferromagnetic slug may be provided for affixing the magnetic hanging apparatus 102 to a suitable surface. The secondary magnet 150 may be configured to be operably connected to the magnet 140 or the first ferromagnetic material. The ferromagnetic slug may be configured to be operably connected to the magnet 140.

The magnet 140 may be press fitted into a recessed portion formed on the second end surface 114 of the body portion 116. When inserted, the magnet 140 may be flush with, inside, or protrude from the second end surface 114. The amount of protrusion of the magnet 140 may be just enough to contact a surface. The amount the magnet 140 protrudes may be 0.002 inches.

Decorative elements 160 may attach to the extension element 130 between the first end surface 112 of the housing element 102 and the first end 132 of the extension element 130. The decorative elements 160 may include beads, tassels, or any other ornamental design element.

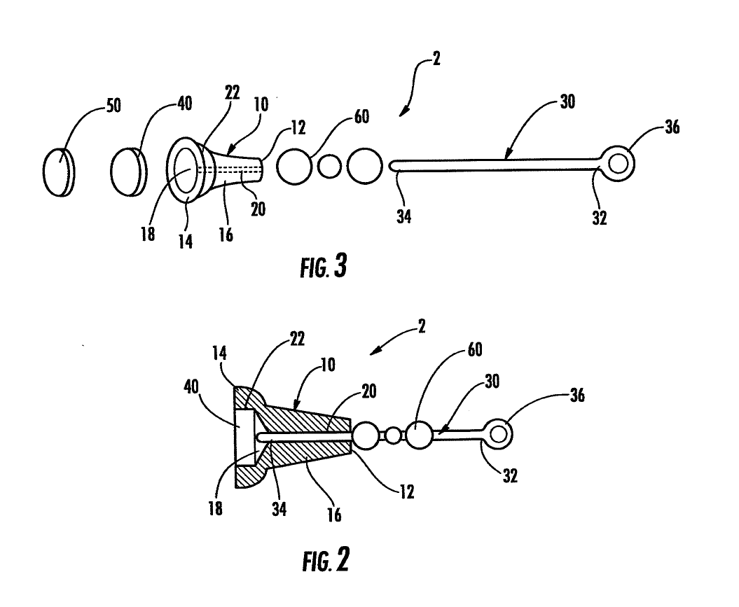

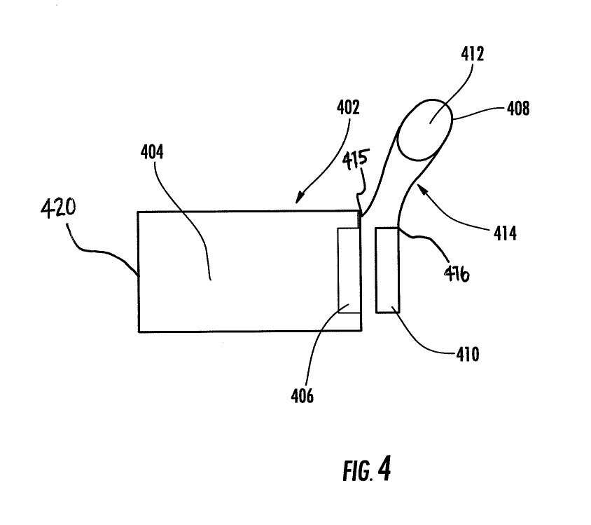

FIGS. 2 and 3 show an embodiment of the magnetic hanging apparatus 2 according to the present application. The magnetic hanging apparatus 2 includes a housing element 10, an extension element 30 partially located within the housing element 10, and a magnet 40 housed in the housing element 10. The housing element 10 may include a ferromagnetic material. The housing element 10 includes a first end surface 12, a second end surface 14, a body portion 16, a central bore 20, and a recessed portion 22 at the second end surface 14. The housing element 10 may be conically shaped. The housing element 10 may be any appropriate size and shape. The housing element 10 may be formed of any suitable material.

A central bore 20 extends axially through a center of the housing element 10. The central bore 20 may extend from the first end surface 12 through the body portion 16 of the housing element 10 to the second end surface 14. The central bore 20 may be connected to the recessed portion 22. The central bore 20 may extend partially through the housing element 10 and may not extend through to the recessed portion 22. The recessed portion 22 of the housing element 10 defines a recess 18. The central bore 20 is shaped for receiving the extension element 30.

The extension element 30 is partially located within the central bore 20 of the housing element 10 and includes a first end 32 and a second end 34. The extension element 30 may be but is not limited to a chain, rod, string, rope, yarn, strap, or cable. The first end 32 extends from the first end surface 12 and away from the body portion 16. The second end 34 is proximal to the recessed portion 22. The first end 32 of the extension element 30 may include a fastening element 36. The fastening element 36 is configured to attach to a feature to be displayed. The feature to be displayed may be an ornament or a display item. The display item may be but is not limited to jewelry. The extension element 30 may be secured in the central bore 20 of the housing element 10 via a press fit. Alternatively, a securing element may be attached to the second end 34 of the extension element 30 such that the extension element 30 is anchored within the recessed portion 22 of the housing element 10 when the securing element is attached. The extension element 30 may be but is not limited to being magnetically retained in the central bore 20. The securing element may be removed from the second end 34 of the extension element 30 for disassembling the apparatus and removing the extension element 30 from the housing element 10. Decorative elements 60, such as beads, may attach to the extension element 30. The decorative elements 60 may be used to symbolize any occasion. The decorative elements 60 may be removed from the magnetic hanging apparatus 2 by removing the extension element 30 from the housing element 10.

The extension element 30 may fill the central bore 20 of the housing element 10. The extension element 30 may be inserted into the central bore 20 of the housing element 10 from the first end and out the second end. After insertion in this manner, the extension element 30 may be crimped to remain in the central bore 20 and a fastening element, if present, may be attached after insertion.

A recessed portion 22 at the second end surface 14 is shaped for receiving a magnet 40. The recessed portion 22 may be enlarged in the axial direction in order to support multiple magnets and increase the amount of weight capable of being held by the hanging apparatus 2. The magnet 40 may be glued in the recessed portion 22 or integral with the recessed portion 22. A flange may extend axially across the recessed portion 22 to support the magnet 40 in the recessed portion 22. As described above with respect to secondary magnet 150, a secondary magnet 50 may be operably connected to the magnetic hanging apparatus 2.

The magnet 40 may be press fitted into recessed portion 22. When inserted, the magnet 40 may be flush with, inside, or protrude from the second end surface 14. The amount the magnet 40 protrudes may be just enough to contact a surface. The amount the magnet 40 protrudes may be 0.002 inches.

A ferromagnetic slug may be provided for affixing the magnetic hanging apparatus 2 to a suitable surface. The secondary magnet 50 may be configured to be operably connected to the magnet 40 or the ferromagnetic material. The ferromagnetic slug may be configured to be operably connected to the magnet 40.

FIG. 4 shows an embodiment of a magnetic hanging apparatus 402 according to the present application. The magnetic hanging apparatus 402 includes a body, shown generically in FIG. 4 as element 404. The body 404 may include an extension element and decorative elements as described above with respect to the other embodiments. The extension element may be fastened to any surface of the body 404. The extension element may be fastened to end 420. The extension element may be a chain, rod, or cable. A connector 406 represents a portion of the body 404 that may include magnetic material. The connector 406 may include a recess. An attachment assembly 414 includes a flexible element 408 with a first terminal end 415 attached to the body 404 and a second terminal end 416 including a fastening element 410 that is operably connected to the connector 406. The flexible element 408 may include a fabric or rubber strap or other non-rigid material. The flexible element 408 may include a hinged configuration with two rigid portions connected at a central hinge. The flexible element 408 may be wrapped around an object, which is generically shown as element 412 in FIG. 4. Element 412 may be a tree branch such that the flexible element 408 wraps around the branch-like element 412 to hold the magnetic hanging apparatus 402 in place. The fastening element 410 may include a magnet or magnetic material. The fastening element 410 aligns with the connector 406 to secure the flexible element 408 around element 412. The fastening element 410 may be inserted into the connector 406 if the connector 406 is formed as a recess of the body 404. In alternative embodiment, the connector 406 may include a snapping element for the terminal end of the flexible element 408. In this embodiment, the connector 406 and terminal end of the flexible element 408 may be a clasp, hook, or button snap.

Many walls and ceilings in buildings are constructed of drywall and contain metal elements behind a layer of drywall. The metal elements behind the drywall make these surfaces suitable for attachment of magnetic elements to the walls and ceilings at these locations. Additionally, most buildings feature a number of metal columns, corner mounts, arches, light switches, ventilation ducts and registers, track-lighting beams, and nail heads, all of which can provide suitable metal surfaces for attaching a magnetic element. The metal channels used for holding ceiling tiles in drop ceilings provide a suitable metal surface for attaching a magnetic element. The examples above in this paragraph are merely illustrative, and not limiting the types of surfaces to affix an apparatus or system herein to. Any magnetic hanging apparatus or system herein may be magnetically affixed to a surface.

Methods herein include implementation of any magnetic hanging apparatus or system herein to affix ornaments or any other display item to a surface.

A method of decorating or providing a display includes affixing a magnetic hanging apparatus to a surface and attaching an ornament or display item thereto. Affixing includes pressing a second end surface of a housing element against the surface. A second magnet may be placed on an opposite side of the surface in comparison to the second end of the housing element and a first magnet and the second magnet are operably connected to keep the magnetic hanging apparatus in place.

A method of decorating or providing a display may include affixing a magnetic hanging apparatus on a substrate element by wrapping a flexible element around the substrate element and operably connecting a second end of the flexible element to a connector of a body.

A decoration system may include a magnetic hanging apparatus according to any one of the above-described embodiments. The decoration system may also include at least one of the following: secondary magnets, and occasion specific decorations. The occasion specific decorations may be directed to any event, including, but not limited to: graduations, anniversaries, birthdays, retirements, New Year's day, Valentine's day, Presidents' day, St. Patrick's day, Easter, Mother's day, Memorial day, Father's day, Earth day, Flag day, Independence day, Labor day, Halloween, Election day, Veterans day, Thanksgiving, Pongal, Vesak, Eid ul-Fitr, Kwanzaa, Hanukkah, and Christmas. The decoration system may include a pack including decorations for just one occasion or a pack including decorations for multiple occasions, such as a patriotic pack, which could include decorations for Presidents' day, Flag day, Independence day, Labor day, Election day, and Veterans day.

The magnetic hanging apparatus of any of the above embodiments may include a light element, such as a light-emitting diode (LED). The light element may be attached to any portion of the magnetic hanging apparatus. A battery may be used to power the light or any other electronic element. The battery may be housed within the housing of the magnetic hanging apparatus. The magnets of any of the above embodiments can vary in size and strength. The housing of the magnetic hanging apparatus may be any size to accommodate the magnets.

An extension element herein may be non-ferromagnetic. A body may be non-ferromagnetic. An extension element may be ferromagnetic. The body may be ferromagnetic.

The magnetic hanging apparatus of any of the above embodiments may be formed by injection molding. The injection molded magnetic hanging apparatus may include a magnet that is inserted in the housing of the magnetic hanging apparatus. The magnet may be press fit to be secured within the housing.

### EMBODIMENTS

The following list includes particular embodiments of the present invention. The list, however, is not limiting and does not exclude alternate embodiments, as would be appreciated by one of ordinary skill in the art.
1. A magnetic hanging apparatus comprising:
   a housing element having a first end surface, a second end surface, and a body portion, wherein the second end surface includes at least one of a first magnet or a first ferromagnetic material; and
   an extension element having a first end and a second end, wherein the first end of the extension element extends from the first end surface and away from the body portion and the second end is fastened to the body portion.
2. The magnetic hanging apparatus of embodiment 1, wherein the first magnet is integral with the second end surface.
3. The magnetic hanging apparatus of any one or more of embodiments 1-2, wherein the second end of the extension element is fastened to the first end surface.
4. The magnetic hanging apparatus of any one or more of embodiments 1-3, wherein the first end of the extension element includes a fastening element, wherein the fastening element is configured to retain an ornament or display item.
5. The magnetic hanging apparatus of any one or more of embodiments 1-4, further comprising decorative elements that attach to at least one of 1) the extension element between the first end surface of the housing element and the first end of the extension element, or 2) the housing element.
6. The magnetic hanging apparatus of any one or more of embodiments 1-5, further comprising at least one of a second magnet or a second ferromagnetic slug, wherein the second magnet is configured to be operably connected to the first magnet or the first ferromagnetic material, and wherein the second ferromagnetic slug is configured to be operably connected to the first magnet.
7. A method of decorating or providing a display comprising:
   affixing the magnetic hanging apparatus of any one or more of embodiments 1-6 to a surface and attaching an ornament or display item thereto.
8. The method of embodiment 7, wherein affixing includes pressing the second end surface of the housing element against the surface.
9. The method of any one or more of embodiments 7-8, further comprising placing the second magnet or the second ferromagnetic slug on an opposite side of the surface in comparison to the second end of the housing element.
10. A magnetic hanging apparatus comprising:
   a housing element having a first end surface, a second end surface, a body portion, a central bore extending through the body portion from the first end surface to the second end surface, and a recessed portion at the second end surface;
   an extension element partially located within the central bore and having a first end and a second end, the first end extends from the first end surface and away from the body portion, and the second end is fastened to the recessed portion; and
   at least one of a magnet or ferromagnetic material housed in the recessed portion.
11. The magnetic hanging apparatus of embodiment 10, wherein the first end surface and the second end surface are annular.
12. The magnetic hanging apparatus of any one or more of embodiments 10-11, wherein the cross section of the first end surface is smaller than the cross section of the second end surface.
13. The magnetic hanging apparatus of any one or more of embodiments 10-12, wherein the first end of the extension element includes a fastening element, wherein the fastening element is configured to retain an ornament or display item.
14. The magnetic hanging apparatus of any one or more of embodiments 10-13, further comprising at least one of a secondary magnet or a ferromagnetic slug, wherein the secondary magnet is configured to be operably connected to the magnet or the ferromagnetic material, and wherein the ferromagnetic slug is configured to be operably connected to the magnet.
15. The magnetic hanging apparatus of any one or more of embodiments 10-14, further comprising decorative elements attached to the extension element between the first end surface of the housing element and the first end of the extension element.
16. The magnetic hanging apparatus of any one or more of embodiments 10-15, further comprising decorative elements attached to the housing element.
17. A method of decorating or providing a display comprising:
   affixing the magnetic hanging apparatus of any one or more of embodiments 10-16 to a surface and attaching an ornament or display item thereto.
18. The method of embodiment 17, wherein affixing includes pressing the second end surface of the housing element against the surface.
19. The method of any one or more of embodiments 17-18, wherein the secondary magnet or the ferromagnetic slug is placed on an opposite side of the surface in comparison to the magnet or the ferromagnetic material.
20. A magnetic hanging apparatus comprising:
   a body including a connector at an axial end of the body, wherein the connector includes at least one of a magnet, recess, or ferromagnetic material, and
   an attachment assembly including a flexible element with a first end fastened to the body and a second end fastened to a fastening element that is operably connected to the connector.
21. A method of decorating or providing a display comprising:
   affixing the magnetic hanging apparatus of embodiment 20 on a substrate element by wrapping the flexible element around the substrate element and operably connecting the second end of the flexible element to the connector of the body.
22. A decoration system including a magnetic hanging apparatus of any one or more of embodiments 1-21, further comprising at least one occasion specific decoration.
23. The decoration system of embodiment 22, wherein the at least one occasion specific decoration is a plurality of occasion specific decorations, and more than one occasion is represented by the plurality of occasion specific decorations.

Further embodiments herein may be formed by supplementing an embodiment with one or more element from any one or more other embodiment herein, and/or substituting one or more element from one embodiment with one or more element from one or more other embodiment herein.

Having thus described various embodiments of the present invention in detail, it is to be appreciated and will be apparent to those skilled in the art that many physical changes, only a few of which are exemplified in the detailed description above, could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A magnetic hanging apparatus comprising:
a housing element having a first end surface, a second end surface, and a body portion, wherein the second end surface includes at least one of a first magnet or a first ferromagnetic material; and
an extension element having a first end and a second end, wherein the first end of the extension element extends from the first end surface and away from the body portion and the second end is fastened to the body portion.

2. The magnetic hanging apparatus of claim 1, wherein the first magnet is integral with the second end surface.

3. The magnetic hanging apparatus of claim 1, wherein the second end of the extension element is fastened to the first end surface.

4. The magnetic hanging apparatus of claim 1, wherein the first end of the extension element includes a fastening element, wherein the fastening element is configured to retain an ornament or display item.

5. The magnetic hanging apparatus of claim 1, further comprising decorative elements that attach to at least one of 1) the extension element between the first end surface of the housing element and the first end of the extension element, or 2) the housing element.

6. The magnetic hanging apparatus of claim 1, further comprising at least one of a second magnet or a second ferromagnetic slug, wherein the second magnet is configured to be operably connected to the first magnet or the first ferromagnetic material, and wherein the second ferromagnetic slug is configured to be operably connected to the first magnet.

7. A method of decorating or providing a display comprising:
affixing the magnetic hanging apparatus of claim 1 to a surface and attaching an ornament or display item thereto.

8. The method of claim 7, wherein affixing includes pressing the second end surface of the housing element against the surface.

9. The method of claim 7, wherein the magnetic hanging apparatus further includes at least one of a second magnet or a second ferromagnetic slug, and the method further comprising placing the second magnet or the second ferromagnetic slug on an opposite side of the surface in comparison to the second end of the housing element.

10. A magnetic hanging apparatus comprising:
a housing element having a first end surface, a second end surface, a body portion, a central bore extending through the body portion from the first end surface to the second end surface, and a recessed portion at the second end surface;
an extension element partially located within the central bore and having a first end and a second end, the first end extends from the first end surface and away from the body portion, and the second end is fastened to the recessed portion; and
at least one of a magnet or ferromagnetic material housed in the recessed portion.

11. The magnetic hanging apparatus of claim 10, wherein the first end surface and the second end surface are annular.

12. The magnetic hanging apparatus of claim 10, wherein the cross section of the first end surface is smaller than the cross section of the second end surface.

13. The magnetic hanging apparatus of claim 10, wherein the first end of the extension element includes a fastening element, wherein the fastening element is configured to retain an ornament or display item.

14. The magnetic hanging apparatus of claim 10, further comprising at least one of a secondary magnet or a ferromagnetic slug, wherein the secondary magnet is configured to be operably connected to the magnet or the ferromagnetic material, and wherein the ferromagnetic slug is configured to be operably connected to the magnet.

15. The magnetic hanging apparatus of claim 10, further comprising decorative elements attached to the extension element between the first end surface of the housing element and the first end of the extension element.

16. The magnetic hanging apparatus of claim 10, further comprising decorative elements attached to the housing element.

17. A method of decorating or providing a display comprising:
affixing the magnetic hanging apparatus of claim 10 to a surface and attaching an ornament or display item thereto.

18. The method of claim 17, wherein affixing includes pressing the second end surface of the housing element against the surface.

19. The method of claim 17, wherein the magnetic hanging apparatus further includes a secondary magnet or a ferromagnetic slug, and the method further comprises placing the secondary magnet or the ferromagnetic slug on an opposite side of the surface in comparison to the magnet or the ferromagnetic material.

20. A magnetic hanging apparatus comprising:
a body including a connector at an axial end of the body, wherein the connector includes at least one of a magnet, recess, or ferromagnetic material, and
an attachment assembly including a flexible element with a first end fastened to the body and a second end fastened to a fastening element that is operably connected to the connector.

21. A method of decorating or providing a display comprising:
affixing the magnetic hanging apparatus of claim 20 on a substrate element by wrapping the flexible element around the substrate element and operably connecting the second end of the flexible element to the connector of the body.

22. A decoration system including a magnetic hanging apparatus of claim 1, further comprising at least one occasion specific decoration.

23. The decoration system of claim 22, wherein the at least one occasion specific decoration is a plurality of occasion specific decorations, and more than one occasion is represented by the plurality of occasion specific decorations.
